(19) United States
(12) Patent Application Publication
(10) Pub. No.: US 2012/0093323 A1
(43) Pub. Date: Apr. 19, 2012

(54) AUDIO SYSTEM AND METHOD OF DOWN MIXING AUDIO SIGNALS USING THE SAME

(75) Inventors: Young-woo LEE, Suwon-si (KR); Sun-min KIM, Yongin-si (KR); Kyeong-ok KANG, Daejeon (KR); Jin-woong KIM, Daejeon (KR); Jeong-il SEO, Daejeon (KR); Jae-hyoun YOO, Daejeon (KR)

(73) Assignee: SAMSUNG ELECTRONICS CO., LTD., Suwon-si (KR)

(21) Appl. No.: 13/273,568

(22) Filed: Oct. 14, 2011

Related U.S. Application Data
(60) Provisional application No. 61/393,066, filed on Oct. 14, 2010.

(30) Foreign Application Priority Data
Sep. 27, 2011 (KR) 10-2011-0097573

(51) Int. Cl. H04R 5/02; H04R 5/00

(52) U.S. Cl. 381/23; 381/307

(57) ABSTRACT

An audio system that provides an optimized sense of realism and an optimized three-dimensional effect to a user, the audio system including: a horizontal plane speaker set including a center channel speaker that is disposed at a reference point, a left channel speaker and a right channel speaker that are disposed at points in right and left directions of the reference point, and at least one first channel speaker and at least one second channel speaker that are disposed in right and left directions of the reference point, respectively; and a vertical plane speaker set including a left height channel speaker and a right height channel speaker that are respectively disposed in right and left directions of the reference point and in a vertical direction of the reference point, and a center height channel speaker that is disposed in the vertical direction of the reference point.

### CROSS-REFERENCE TO RELATED PATENT APPLICATION

This application claims priority from U.S. Provisional Application No. 61/393,066, filed on Oct. 14, 2010, in the United States Patent and Trademark Office, and claims priority from Korean Patent Application No. 10-2011-0097573, filed on Sep. 27, 2011, in the Korean Intellectual Property Office, the disclosures of which are incorporated herein in their entirety by reference.

### BACKGROUND

1. Field

Methods and apparatuses consistent with the exemplary embodiments relate to an audio system and a method of down mixing audio signals using the audio system, and more particularly, to an audio system that provides a sense of realism and a three-dimensional effect to a user, and a method of down mixing audio signals using the audio system.

2. Description of the Related Art

In order to increase a three-dimensional effect and a sense of realism when a user listens to an audio system, audio systems that reproduce multi-channel audio signals through a plurality of speakers have been developed. Audio systems that output multi-channel audio signals are referred to as multi-channel audio systems. Here, multi-channel audio signals may include a plurality of separated audio signals, and each of the plurality of audio signals may be output to different speakers.

For example, audio systems that output 5.1 channel audio signals, output six audio signals to six speakers. In detail, five audio signals L, R, C, SL, and SR are output to five speakers disposed in right and left directions of a front layer, a center of the front layer, and left and right surround directions of a rear layer, respectively. Audio signals in sub-woofer sound are output to a sub-woofer speaker for a low frequency effect.

As the number of channels included in multi-channel audio signals increases and the number of speakers included in an audio system increases, more three-dimensional sound may be realized.

However, when the number of speakers included in an audio system increases, cost for manufacturing an audio system and power consumption of the audio system increase. Thus, there is a need to provide audio systems that provide a maximized sense of concentration, a maximized sense of realism, and a maximized three-dimensional effect to the user.

In addition, a method and apparatus for down mixing audio signals whereby compatibility between audio systems that can maximize a sense of concentration, a sense of realism, and a three-dimensional effect, and whereby existing 2.0 channel, 5.1 channel or 7.1 channel audio systems can be maintained, needs to be provided.

### SUMMARY

One or more exemplary embodiments provide an audio system that may provide a maximized sense of realism and a maximized three-dimensional effect to a user, and a method of down mixing audio signals using the audio system.

One or more exemplary embodiments also provide a method of down mixing audio signals by using the audio system, whereby compatibility between the audio system and multi-channel audio systems having a different number of channels may be maintained.

According to an aspect of an exemplary embodiment, there is provided an audio system including: a horizontal plane speaker set including a center channel speaker that is disposed at a reference point that corresponds to 0 degrees in a front direction of a horizontal plane, a left channel speaker and a right channel speaker that are disposed at points that respectively correspond to 30 degrees in right and left directions of the reference point, and at least one first channel speaker and at least one second channel speaker that are disposed at an angle in the range of 60 to 150 degrees in right and left directions of the reference point, respectively; and a vertical plane speaker set including a left height channel speaker and a right height channel speaker that are respectively disposed at an angle in the range of 30 to 45 degrees in right and left directions of the reference point and at an angle in the range of 30 to 45 degrees in a vertical direction of the reference point, and a center height channel speaker that is disposed at an angle in the range of 90 to 150 degrees in the vertical direction of the reference point.

The at least one first channel speaker may include a left side channel speaker and a left back channel speaker that are disposed at an angle in the range of 60 to 150 degrees in a left direction of the reference point, and the at least one second channel speaker may include a right side channel speaker and a right back channel speaker that are disposed at an angle in the range of 60 to 150 degrees in a right direction of the reference point.

The left side channel speaker may be disposed at an angle that is adjacent to 60 degrees in a left direction of the reference point, and the left back channel speaker may be disposed at an angle that is adjacent to 150 degrees in a left direction of the reference point, and the right side channel speaker may be disposed at an angle that is adjacent to 60 degrees in a right direction of the reference point, and the right back channel speaker may be disposed at an angle that is adjacent to 150 degrees in a right direction of the reference point.

The audio system may further include a woofer speaker set including at least one sub woofer speaker.

The woofer speaker set may include a left channel woofer speaker and a right channel woofer speaker that are respectively disposed at an angle in the range of 30 to 90 degrees in right and left directions of the reference point.

The woofer speaker set may include one of a left channel woofer speaker and a right channel woofer speaker that are respectively disposed at an angle in the range of 30 to 90 degrees in right and left directions of the reference point.

The at least one first channel speaker and the at least one second channel speaker may include a left side channel speaker and a right side channel speaker that are respectively disposed at an angle in the range of 100 to 120 degrees in right and left directions of the reference point.

According to another aspect of an exemplary embodiment, there is provided an audio system including: a horizontal plane speaker set including a center channel speaker that is disposed at a reference point that corresponds to 0 degrees in a front direction of a horizontal plane, a left channel speaker and a right channel speaker that are disposed at points that respectively correspond to 30 degrees in right and left directions of the reference point, and at least one first channel speaker and at least one second channel speaker that are disposed at an angle in the range of 60 to 150 degrees in right and left directions of the reference point, respectively; and a vertical plane speaker set including a left height channel speaker and a right height channel speaker that are respectively disposed at an angle in the range of 30 to 45 degrees in right and left directions of the reference point and at an angle in the range of 30 to 45 degrees in a vertical direction of the reference point, and a left back height channel speaker and a right back height channel speaker that are respectively disposed at an angle in the range of 135 to 150 degrees in right and left directions of the reference point and at an angle in the range of 135 to 150 degrees in the vertical direction of the reference point.

According to another aspect of an exemplary embodiment, there is provided an audio system including: an audio signal generator for receiving predetermined audio signals and down mixing the predetermined audio signals according to the number of speakers of a speaker unit to generate at least one down-mixed signal; and the speaker unit including at least one speaker that outputs the at least one down-mixed signal.

The predetermined audio signals may include center channel audio signals corresponding to a center channel speaker that is disposed at a reference point that corresponds to 0 degrees in a front direction of a horizontal plane, left channel audio signals and right channel audio signals that respectively correspond to a left channel speaker and a right channel speaker that are disposed at points that respectively correspond to 30 degrees in right and left directions of the reference point, at least one first channel audio signals and at least one second channel audio signals that respectively correspond to at least one first channel speaker and at least one second channel speaker that are disposed at an angle in the range of 60 to 150 degrees in right and left directions of the reference point, respectively, left height channel audio signals and right height channel audio signals that respectively correspond to a left height channel speaker and a right height channel speaker that are respectively disposed at an angle in the range of 30 to 45 degrees in right and left directions of the reference point and at an angle in the range of 30 to 45 degrees in a vertical direction of the reference point, and center height channel audio signals that correspond to a center height channel speaker that is disposed at an angle in the range of 90 to 150 degrees in the vertical direction of the reference point.

The speaker unit may include speakers that output at least one channel audio signal selected from the group consisting of 7.1, 5.1, and 2.0 channel audio signals.

According to another aspect of an exemplary embodiment, there is provided a method of down mixing audio signals, including: receiving audio signals including center channel audio signals corresponding to a center channel speaker that is disposed at a reference point that corresponds to 0 degrees in a front direction of a horizontal plane, left channel audio signals and right channel audio signals that respectively correspond to a left channel speaker and a right channel speaker that are disposed at points that respectively correspond to 30 degrees in right and left directions of the reference point, at least one first channel audio signals and at least one second channel audio signals that respectively correspond to at least one first channel speaker and at least one second channel speaker that are disposed at an angle in the range of 60 to 150 degrees in right and left directions of the reference point, respectively, left height channel audio signals and right height channel audio signals that respectively correspond to a left height channel speaker and a right height channel speaker that are respectively disposed at an angle in the range of 30 to 45 degrees in right and left directions of the reference point and at an angle in the range of 30 to 45 degrees in a vertical direction of the reference point, and center height channel audio signals that correspond to a center height channel speaker that is disposed at an angle in the range of 90 to 150 degrees in the vertical direction of the reference point; and generating down-mixed signals by down mixing the received audio signals into 7.1, 5.1 or 2.0 channel audio signals.

The generating of the down-mixed signals may include generating the down-mixed signals corresponding to one channel based on at least one of predetermined channel audio signal among the received audio signals that corresponds to at least one speaker that is disposed in the same or adjacent vertical line.

The receiving of the audio signals may include receiving 10.2 channel audio signals including the at least one first channel audio signals, the center channel audio signal C, the left channel audio signal L and the right channel audio signal R, and left side channel audio signal LS and left back channel audio signal LB, the at least one second channel audio signals including right side channel audio signal RS and right back channel audio signal RB, left height channel audio signal LH and right height channel audio signal RH, center height channel audio signal CH, and left woofer channel audio signal LFEL and right woofer channel audio signal LFER that respectively correspond to a left channel woofer speaker and a right channel woofer speaker that are respectively disposed at an angle in the range of 30 to 90 degrees in right and left directions of the reference point.

The receiving of the audio signals may include receiving 8.2 channel audio signals including the at least one first channel audio signals the center channel audio signal C, the left channel audio signal L and the right channel audio signal R, and left side channel audio signal LS, the at least one second channel audio signals including the right side channel audio signal RS, left height channel audio signal LH and right height channel audio signal RH, center height channel audio signal CH, and left woofer channel audio signal LFEL and right woofer channel audio signal LFER that respectively correspond to a left channel woofer speaker and a right channel woofer speaker that are respectively disposed at an angle in the range of 30 to 90 degrees in right and left directions of the reference point.

### BRIEF DESCRIPTION OF THE DRAWINGS

The above and other features will become more apparent by describing in detail exemplary embodiments with reference to the attached drawings in which:

FIGS. 1A through 1D illustrate an audio system according to an exemplary embodiment;

FIG. 2 illustrates an audio system according to an exemplary embodiment;

FIGS. 3A and 3B illustrate a method of down mixing audio signals according to an exemplary embodiment;

FIGS. 4A and 4B illustrate a method of down mixing audio signals according to an exemplary embodiment;

FIGS. 5A and 5B illustrate a method of down mixing audio signals according to an exemplary embodiment;

FIGS. 6A and 6B illustrate a method of down mixing audio signals according to an exemplary embodiment;

FIGS. 7A and 7B illustrate a method of down mixing audio signals according to an exemplary embodiment;

FIGS. 8A and 8B illustrate a method of down mixing audio signals according to an exemplary embodiment;

FIGS. 9A through 9C illustrate an audio system for 22.2 channel that is used in a method of down mixing audio signals, according to an exemplary embodiment;

FIG. 10 illustrates an audio system according to an exemplary embodiment;

FIGS. 11A and 11B illustrate a method of down mixing audio signals according to an exemplary embodiment;

FIGS. 12A and 12B illustrate a method of down mixing audio signals according to an exemplary embodiment;

FIGS. 13A through 13D illustrate an audio system according to an exemplary embodiment;

FIGS. 14A and 14B illustrate a method of down mixing audio signals according to an exemplary embodiment;

FIGS. 15A and 15B illustrate a method of down mixing audio signals according to an exemplary embodiment;

FIGS. 16A and 16B illustrate a method of down mixing audio signals according to an exemplary embodiment;

FIGS. 17A and 17B illustrate a method of down mixing audio signals according to an exemplary embodiment; and

FIGS. 18A and 18B illustrate a method of down mixing audio signals according to an exemplary embodiment.

### DETAILED DESCRIPTION OF EXEMPLARY EMBODIMENTS

Exemplary embodiments will now be described more fully with reference to the accompanying drawings.

In order to provide an increased sense of realism and an increased three-dimensional effect to a user when audio signals are reproduced by an audio system, a 22.2 channel audio system that reproduces 22.2 channel audio signals by using 24 loud speakers has been developed. The 22.2 channel audio system may output 22.2 channel signals, i.e., 24 independent audio signals, to 24 speakers, thereby maximizing a user's sense of realism and three-dimensional effect. However, since the 22.2 channel audio system has a number of speakers, cost for manufacturing the 22.2 channel audio system and power consumption thereof are increased, and a larger space is required to install the 22.2 channel audio system.

Hereinafter, an audio system according to an exemplary embodiment that may provide almost the same sense of realism and three-dimensional effect as those of the 22.2 channel audio system by including only 10 to 12 speakers, and a method of down mixing audio signals using the audio system according to an exemplary embodiment will be described in detail as below.

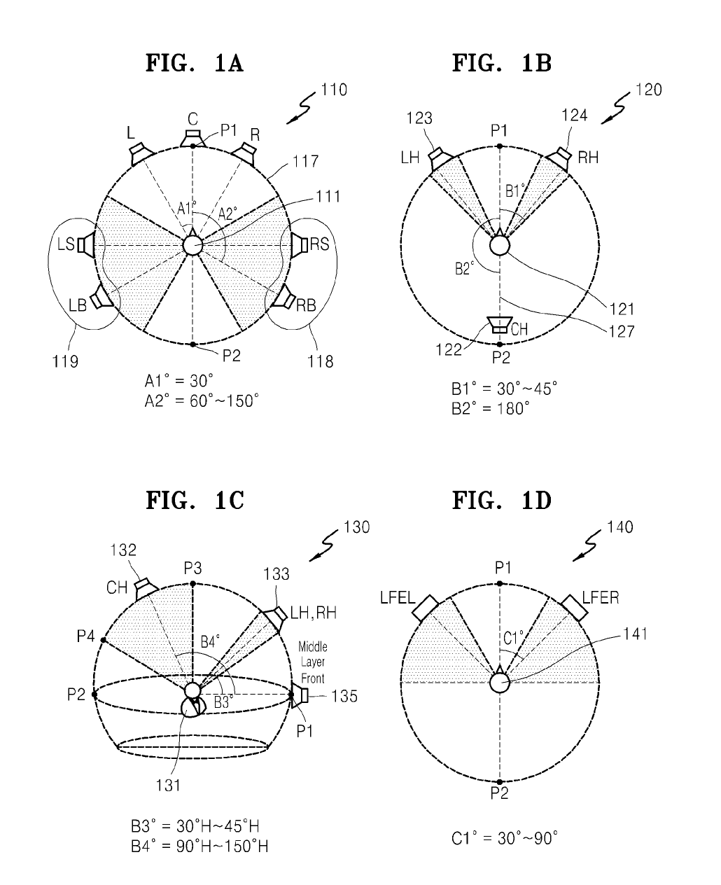

FIGS. 1A through 1D illustrate an audio system according to an exemplary embodiment.

Referring to FIGS. 1A through 1D, the audio system according to an exemplary embodiment includes a horizontal plane speaker set 110 that is disposed on a horizontal plane, as illustrated in FIG. 1A and vertical plane speaker sets 120 and 130 that are disposed on a vertical plane, as illustrated in FIGS. 1B and 1C, respectively. Also, the audio system illustrated in FIGS. 1A through 1D may further include a woofer speaker set that is disposed, as illustrated in FIG. 1D.

FIG. 1A illustrates a horizontal plane speaker set 110 disposed on the horizontal plane of the audio system of FIGS. 1A through 1D.

Referring to FIG. 1A, the horizontal plane speaker set 110 includes a center channel speaker C that is disposed centering on a sweet spot 111, a left channel speaker L and a right channel speaker R, and at least one first channel speaker 119, and at least one second channel speaker 118. Here, the sweet spot 111 refers to a point in which a listener who is a user of the audio system can listen to optimized audio signals. A plurality of speakers included in the horizontal plane speaker set 110 may be disposed in the same distance line such as circle line 117 from the sweet spot 111.

Hereinafter, a point where a speaker is disposed in front of the sweet spot 111 on the horizontal plane, is referred to as a reference point P1. In detail, the reference point P1 corresponds to 0 degrees in a front direction of the sweet spot 111 that is a user's reference position.

The center channel speaker C is disposed at the reference point P1 corresponding to 0 degrees in the front direction of the sweet spot 111 on the horizontal plane.

The left channel speaker L and the right channel speaker R are disposed at points that respectively correspond to 30 degrees (A1) in left and right directions of the reference point P1. That is, the left channel speaker L is disposed in a left front direction of the horizontal plane and outputs left channel audio signals. The right channel speaker R is disposed in a right front direction of the horizontal plane and outputs right channel audio signals.

At least one first channel speaker 119 and at least one second channel speaker 118 are disposed at an angle in the range of 60 to 150 degrees (A2) in left and right directions of the reference point P1, respectively. In detail, each of the first channel speaker 119 and the second channel speaker 118 may include one or two speakers. FIG. 1A illustrates the first channel speaker 119 and the second channel speaker 118 each including two speakers.

In detail, the first channel speaker 119 may include left side channel speaker LS and a left back channel speaker LB that are disposed at an angle in the range of 60 to 150 degrees (A2) in a left direction of the reference point P1. The left side channel speaker LS is disposed in the left front direction of the horizontal plane, and the left back channel speaker LB is disposed in a left back direction of the horizontal plane.

In detail, the left side channel speaker LS is disposed at an angle that is adjacent to 60 degrees in a left direction of the reference point P1 and outputs left side channel audio signals. Also, the left back channel speaker LB is disposed at an angle that is adjacent to 150 degrees in a left direction of the reference point P1 and outputs left back channel audio signals.

Also, the second channel speaker 118 may include a right side channel speaker RS and a right back channel speaker RB that are disposed at an angle in the range of 60 to 150 degrees (A2) in a right direction of the reference point P1. The right side channel speaker RS is disposed in a right front direction of the horizontal plane and outputs right side channel audio signals. Also, the right back channel speaker RB is disposed in a right back direction of the horizontal plane and outputs right back channel audio signals.

In detail, the right side channel speaker RS is disposed at an angle that is adjacent to 60 degrees in a right direction of the reference point P1. Also, the right back channel speaker RB is disposed at an angle that is adjacent to 150 degrees in a right direction of the reference point P1.

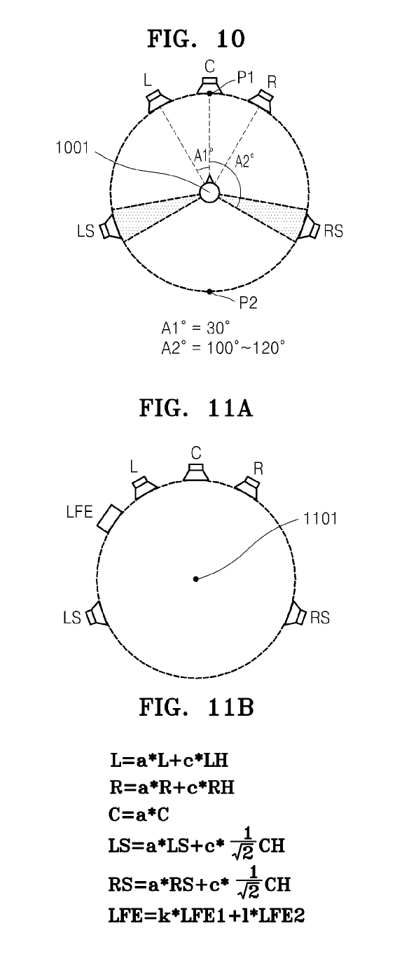

FIG. 1B illustrates the in-plane vertical plane speaker set 120 that is disposed on the vertical plane of the audio system illustrated in FIGS. 1A through 1B. FIG. 10 illustrates the vertical plane speaker set 130 that is disposed on the vertical plane of the audio system illustrated in FIGS. 1A through 1B in a three-dimensional manner.

Referring to FIGS. 1B and 1C, each of the vertical plane speaker sets 120 and 130 includes a left height channel speaker LH and a right height channel speaker RH, and a center height channel speaker CH. Sweet spots 121 and 131 correspond to the sweet spot 111 illustrated in FIG. 1A. FIG. 10 illustrates the case where the user is at the sweet spot 131, for example. Also, a center channel speaker 135 that is disposed at a point corresponding to 0 degrees from the front of the user corresponds to the center channel speaker C illustrated in FIG. 1A.

The left height channel speaker LH of FIG. 1B is disposed at an angle in the range of 30 to 45 degrees (B1) in the left horizontal direction of the reference point P1, and the left height channel speaker LH of FIG. 10 is disposed at an angle in the range of 30 to 45 degrees (B3) in the horizontal direction of the reference point P1. The left height channel speaker LH of FIG. 1B or 1C outputs left height channel audio signals.

The right height channel speaker RH of FIG. 1B is disposed at an angle in the range of 30 to 45 degrees (B1) in the right horizontal direction of the reference point P1, and the right height channel speaker RH of FIG. 10 is disposed at an angle in the range of 30 to 45 degrees (B3) in the horizontal direction of the reference point P1. The right height channel speaker RH of FIG. 1B or 1C outputs right height channel audio signals.

The center height channel speaker CH of FIG. 1B or 1C is disposed at an angle in the range of 90 to 150 degrees in the vertical direction of the reference point P1 and outputs center height channel audio signals. Also, the center height channel speaker CH is disposed opposite to the reference point P1, that is, in a line 127 formed by connecting a point P2 where the sweet spot 121 is moved by 180 degrees in the horizontal direction of the reference point, as illustrated in FIG. 1B.

In detail, the center height channel speaker CH of FIG. 10 may be disposed adjacent to a point P3 where the sweet spot 131 is moved by 90 degrees in the vertical direction from the reference point P1. When the center height channel speaker CH of FIG. 10 is disposed adjacent to the point P3, the center height channel speaker CH of FIG. 10 is disposed on the sweet spot 131 on the horizontal plane.

Alternatively, the center height channel speaker CH of FIG. 10 may be disposed adjacent to a point P4 where the sweet spot 131 is moved by 150 degrees in the vertical direction from the reference point P1. When the center height channel speaker CH of FIG. 10 is disposed adjacent to the point P4, the center height channel speaker CH of FIG. 10 is disposed on the sweet spot 131 adjacent to the point P2 on the horizontal plane.

FIG. 1D illustrates a woofer speaker set that may be included in the audio system illustrated in FIGS. 1A through 1B.

Referring to FIG. 1D, a woofer speaker set 140 includes at least one sub woofer speaker or a low frequency effect speaker. In detail, the woofer speaker set 140 may include one or two sub woofer speakers.

In detail, the woofer speaker set 140 may include a left channel woofer speaker LFEL and a right channel woofer speaker LFER that are respectively disposed at an angle in the range of 30 to 90 degrees (C1) in left and right directions of the reference point P1. The left channel woofer speaker LFEL and the right channel woofer speaker LFER output left channel woofer audio signals and right channel woofer audio signals. FIG. 1D illustrates the case where the woofer speaker set 140 includes one sub woofer speaker LFEL or LFER in each of left and right directions of the horizontal plane.

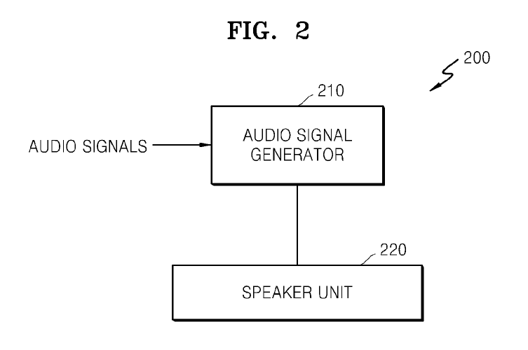

When the audio system of FIGS. 1A through 1D includes 7 speakers that are disposed on the horizontal plane, as illustrated in FIG. 1A, 3 speakers that are disposed on the vertical plane, as illustrated in FIG. 1B and 2 sub woofer speakers that are disposed, as illustrated in FIG. 1D, the audio system of FIGS. 1A through 1D may output 10.2 channel audio signals. In this case, the audio system is referred to as a 10.2 channel audio system.

Alternatively, the woofer speaker set 140 may include one of the left channel woofer speaker LFEL and the right channel woofer speaker LFER that are respectively disposed at an angle in the range of 30 to 90 degrees in right and left directions of the reference point P1 and outputs one of left channel woofer audio signals and right channel woofer audio signals.

In addition, when the audio system of FIGS. 1A through 1D includes 7 speakers that are disposed on the horizontal plane, as illustrated in FIG. 1A, 3 speakers that are disposed on the vertical plane, as illustrated in FIG. 1B and one sub woofer speaker, the audio system of FIGS. 1A through 1D may output 10.1 channel audio signals. In this case, the audio system is referred to as a 10.1 channel audio system.

FIG. 2 illustrates an audio system 200 according to an exemplary embodiment.

Referring to FIG. 2, the audio system 200 may include an audio signal generator 210 and a speaker unit 220.

The audio signal generator 210 receives predetermined audio signals and down mixes or up mixes the received audio signals according to the number of speakers included in the speaker unit 220. The audio signals received by the audio signal generator 210 are multi-channel audio signals, and the number of channels included in the multi-channel audio signals may be modified. For example, the audio signal generator 210 may receive 10.2 channel audio signals, 8.2 channel audio signals, 22.2 channel audio signals, 11.2 channel audio signals, or the like. In addition, the number of channels included in the audio signals output by the audio signal generator 210 may be modified according to the number of speakers included in the speaker unit 220.

The speaker unit 220 may include a plurality of speakers (not shown) for outputting stereoscopic sound. Each of the speakers disposed in the speaker unit 220 outputs audio signals corresponding to different channels. The speaker unit 220 may include the speakers as described above in FIG. 1. That is, the speaker unit 220 may include a plurality of speakers illustrated in FIGS. 1A through 1D.

In addition, the speaker unit 220 may include 6 speakers that may output 5.1 channel audio signals, 8 speakers that may output 7.1 channel audio signals or 2 speakers that may output 2 channel audio signals.

For example, when the audio system 200 receives 10.2 channel audio signals and the speaker unit 220 includes 6 speakers so as to output 5.1 channel audio signals, the audio signal generator 210 down mixes the 10.2 channel audio signals into 5.1 channel audio signals. Then, the speaker unit 220 outputs each of the 5.1 channel audio signals generated by the audio signal generator 210 to 6 speakers.

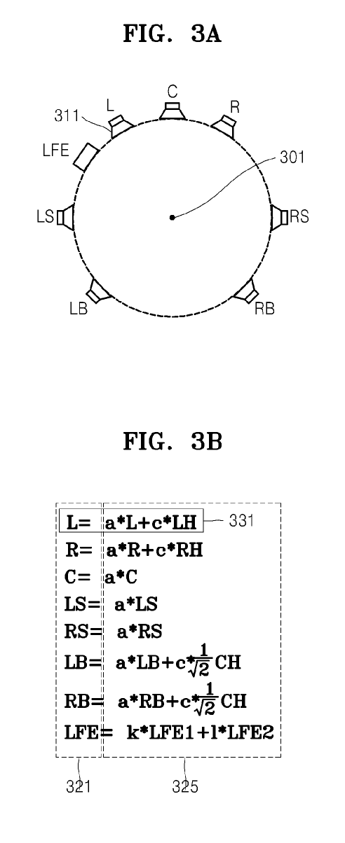

The down-mixing operation performed by the audio signal generator 210 will be described with reference to FIGS. 3 through 7 in detail. Also, FIGS. 3 through 8 illustrate the case where the audio signal generator 210 receives the 10.2 channel audio signals as described above in FIG. 1 and performs an operation of down mixing the 10.2 channel audio signals.

In addition, hereinafter, since predetermined channel audio signals are output from speakers according to predetermined channels, the predetermined channel audio signals are indicated by the same symbols as those of the aforementioned predetermined channel speakers. For example, left channel audio signal that are output from a left channel speaker L is referred to as ‘left channel audio signal L’.

Hereinafter, a method of down mixing audio signals illustrated in FIGS. 3 through 9, FIGS. 11 and 12, and FIGS. 14 through 18, according to one or more exemplary embodiments may be performed by the audio system 200 illustrated in FIG. 2. In detail, the method of down mixing audio signals according to an exemplary embodiment includes receiving the multi-channel audio signals as described above in FIG. 1 by using the audio signal generator 210 and down mixing the audio signals received by the audio signal generator 210 according to predetermined multi-channels and generating down-mixed signals. Hereinafter, the operation of down mixing the audio signals performed by the audio signal generator 210 will be described with reference to FIGS. 3 through 9, FIGS. 11 and 12, and FIGS. 14 through 18.

FIGS. 3A and 3B illustrate a method of down mixing audio signals according to an exemplary embodiment.

FIG. 3A illustrates an example of speakers included in the speaker unit 220. FIG. 3B illustrates an example of the down-mixing operation performed by the audio signal generator 210.

Referring to FIG. 3A, the speaker unit 220 may include 8 speakers L, R, C, LS, RS, LB, RB, and LFE that are disposed around a sweet spot 301. That is, the speaker unit 220 may output 7.1 channel audio signals. Since the speaker unit 220 illustrated in FIG. 3A corresponds to the horizontal plane speaker unit 110 illustrated in FIG. 1A except for the sub woofer speaker LFE, detailed description thereof will not be provided here. The sub woofer speaker LFE corresponds to one of the left channel woofer speaker LFEL and the right channel woofer speaker included in the woofer speaker set 140 illustrated in FIG. 1D.

Audio signals indicated on left terms 321 of equations defined in FIG. 3B represent down-mixed signals that are down-mixed and output audio signals, and audio signals indicated on right terms 325 of the equations defined in FIG. 3B represent audio signals according to channels included in multi-channel audio signals that are received before being down-mixed.

In detail, FIG. 3B shows down-mixing equations when the center height channel speaker CH among the received audio signals of 10.2 channel audio signals is disposed adjacent to the point P4 where the sweet spot 301 is moved by 150 degrees in the vertical direction from the reference point P1 and the center height channel audio signal CH are signals output from a speaker disposed at the point P4.

Referring to FIG. 3B, the down-mixed signals are generated based on at least one predetermined channel audio signal among the received audio signals that is output to at least one speaker that is disposed in the same or adjacent vertical line. In detail, the down-mixed signals may be obtained by adding a result obtained by multiplying at least one, predetermined channel audio signal that is output to at least one speaker that is disposed in the same or adjacent vertical line, among the audio signals input to the audio system 200 by predetermined coefficients a, c, k, and l to the received audio signals.

In addition, when one speaker is disposed in the same or adjacent vertical line, the aforementioned adding-up is not performed. For example, when the center channel speaker C is disposed in the vertical direction of the reference point P1, the center channel audio signal C that are down-mixed signals are generated by multiplying center channel audio signal C among the received 10.2 channel by only a predetermined coefficient a.

Here, the predetermined coefficients a, c, k, and l to be multiplied by each of the audio signals in the down-mixing equations may be modified according to product or design specifications, such as an overall sound level, a maximum rating output, or the like of the audio system 200. For example, when all of the predetermined coefficients a, c, k, and l are 1, down-mixing is performed without additionally controlling a sound level.

For example, referring to FIGS. 1A and 1B, the left height channel speaker LH is disposed in an upper vertical direction adjacent to the left channel speaker L. Thus, referring to equation 331, the left channel audio signal L that are output to the left channel speaker 311 are generated by adding up a value obtained by multiplying the left channel audio signal L among the received 10.2 channel by the predetermined coefficient a and a value obtained by multiplying the left height channel audio signal LH among the received 10.2 channel by the predetermined coefficient c.

Referring to FIG. 3B, each of the right channel audio signal R, the center channel audio signal C, the left side channel audio signal LS, the right side channel audio signal RS, the left back channel audio signal LB, the right back channel audio signal RB, and the woofer channel audio signal LFE that are down-mixed signals may be obtained using the down-mixing equations defined in FIG. 3B. Since the down-mixing equations are clearly defined in FIG. 3B, detailed description thereof will not be provided here.

In FIG. 3B, when the center height channel audio signal CH among channel audio signals are signals output from the speaker disposed at the point P4, the center height channel audio signal CH affects the left back channel audio signal LB and the right back channel audio signal RB that are output on an adjacent vertical plane. In detail, as illustrated in FIG. 3B, the left back channel audio signal LB that is down-mixed and generated are obtained by adding up a value obtained by multiplying the left back channel audio signal LB among the received 10.2 channel audio signals by the predetermined coefficient a and a value obtained by multiplying the left height channel audio signal LH among the received 10.2 channel audio signals by the predetermined coefficient c and a predetermined constant.

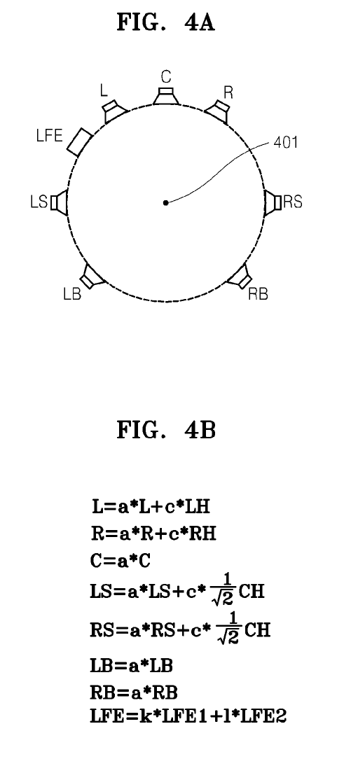

FIGS. 4A and 4B illustrate a method of down mixing audio signals according to another exemplary embodiment. In addition, FIGS. 4A and 4B illustrate the case where the audio signal generator 210 receives the 10.2 channel audio signals as described above in FIG. 1 and performs an operation of down mixing the received 10.2 channel audio signals.

FIG. 4A illustrates another example of speakers included in the speaker unit 220, and FIG. 4B illustrates another example of the down-mixing operation performed by the audio signal generator 210.

Referring to FIG. 4A, the speaker unit 220 may include 8 speakers L, R, C, LS, RS, LB, RB, and LFE that are disposed around a sweet spot 401. Since FIG. 4A corresponds to FIG. 3A, detailed description thereof will not be provided here.

Audio signals indicated on left terms of equations defined in FIG. 4B represent down-mixed signals that are down-mixed and output audio signals, and audio signals indicated on right terms of the equations defined in FIG. 4B represent audio signals that are received before being down-mixed.

In detail, FIG. 4B shows down-mixing equations when the center height channel speaker CH among the received audio signals of 10.2 channel audio signals is disposed adjacent to the point P3 where the sweet spot 401 is moved by 90 degrees in the vertical direction from the reference point P1 and the center height channel audio signal CH are signals output from a speaker disposed at the point P3.

In FIG. 4B, when the center height channel audio signal CH among the 10.2 channel audio signals have been output at the point P3, the center height channel audio signal CH affects the left side channel audio signal LS and the right side channel audio signal RS that are output on an adjacent vertical plane. In detail, as illustrated in FIG. 4B, the left side channel audio signal LS that is down-mixed and generated are obtained by adding up a value obtained by multiplying the left side channel audio signal LS among 10.2 channel audio signals by the predetermined coefficient a and a value obtained by multiplying the center height channel audio signal CH among the 10.2 channel audio signals by the predetermined coefficient c and a predetermined constant.

Referring to FIG. 4B, each of the right channel audio signal R, the center channel audio signal C, the left side channel audio signal LS, the right side channel audio signal RS, the left back channel audio signal LB, the right back channel audio signal RB, and the woofer channel audio signal LFE that are down-mixed signals may be obtained using the down-mixing equations defined in FIG. 4B. Since the down-mixing equations are clearly defined in FIG. 4B, detailed description thereof will not be provided here.

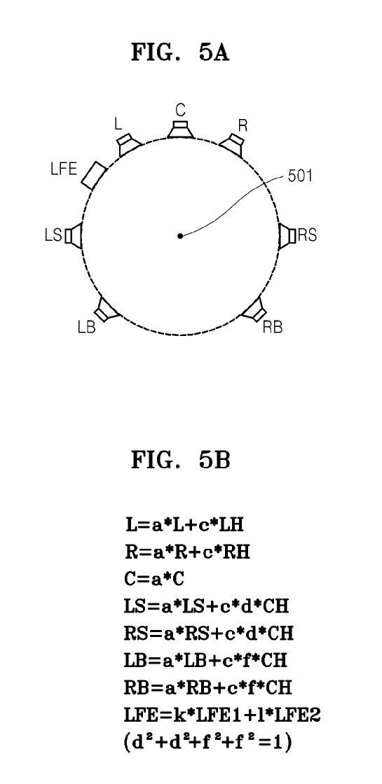

FIGS. 5A and 5B illustrate a method of down mixing audio signals according to another exemplary embodiment.

In addition, FIGS. 5A and 5B illustrate the case where the audio signal generator 210 receives the 10.2 channel audio signals as described above in FIG. 1 and performs an operation of down mixing the received 10.2 channel audio signals.

FIG. 5A illustrates another example of speakers included in the speaker unit 220, and FIG. 5B illustrates another example of the down-mixing operation performed by the audio signal generator 210.

Referring to FIG. 5A, the speaker unit 220 may include 8 speakers L, R, C, LS, RS, LB, RB, and LFE that are disposed around a sweet spot 501. Since FIG. 5A corresponds to FIG. 3A, detailed description thereof will not be provided here.

Audio signals indicated on left terms of down-mixing equations defined in FIG. 5B and other drawings of the present application represent down-mixed signals that are down-mixed and output audio signals, and audio signals indicated on right terms of the down-mixing equations described in FIG. 5B and other drawings of the present application represent indicated on right terms of the equation defined in FIG. 5B represent audio signals that are received before being down-mixed.

In detail, FIG. 5B shows down-mixing equations when the center height channel speaker CH among the received audio signals of 10.2 channel audio signals is disposed at a predetermined point (not shown) at an angle in the range of 90 to 150 degrees in the vertical direction of the reference point P1 and the center height channel audio signal CH is a signal output from a speaker disposed at the predetermined point (not shown) at an angle in the range of 90 to 150 degrees in the vertical direction of the reference point P1.

In FIG. 5B, predetermined coefficients a, c, d, and f that are used in the down-mixing equations may be optimized and set according to an angle at which the center height channel speaker CH is disposed. When the center height channel audio signal CH among the received 10.2 channel audio signals is output at the predetermined point (not shown) at an angle in the range of 90 to 150 degrees in the vertical direction of the reference point P1, the center height channel audio signal CH may affect all of the left side channel audio signal LS, the right side channel audio signal RS, the left back channel audio signal LB, and the right back channel audio signal RB. Thus, when the left side channel audio signal LS, the right side channel audio signal RS, the left back channel audio signal LB, and the right back channel audio signal RB that are down-mixed signals indicated on the left terms of the down-mixing equations are obtained, the center height channel audio signal CH included in the received audio signals is reflected, as in the down-mixing equations defined in FIG. 5B.

Referring to FIG. 5B, each of the right channel audio signal R, the center channel audio signal C, the left side channel audio signal LS, the right side channel audio signal RS, the left back channel audio signal LB, the right back channel audio signal RB, and the woofer channel audio signal LFE that are down-mixed signals may be obtained using the down-mixing equations defined in FIG. 5B.

Since the down-mixing equations that are used in down-mixing the 10.2 channel audio signals into 7.1 channel audio signals are clearly defined in FIG. 5B, detailed description thereof will not be provided here.

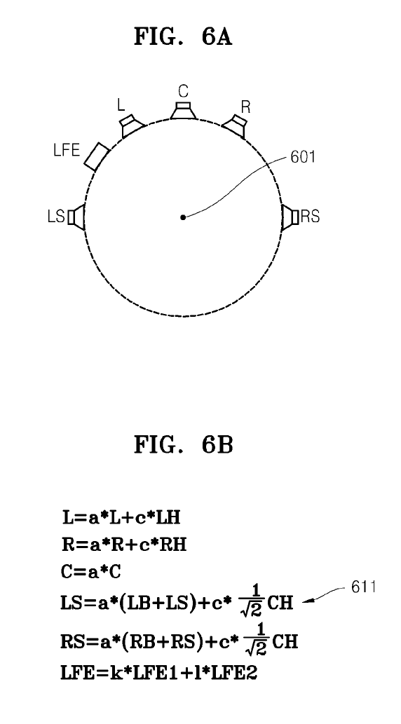

FIGS. 6A and 6B illustrate a method of down mixing audio signals according to another exemplary embodiment. In detail, FIG. 6A illustrates another example of speakers included in the speaker unit 220, and FIG. 6B illustrates another example of the down-mixing operation performed by the audio signal generator 210.

Referring to FIG. 6A, the speaker unit 220 may include 6 speakers L, R, C, LS, RS, and LFE that are disposed around a sweet spot 601. That is, the speaker unit 220 may output 5.1 channel audio signals. Since each of a center channel speaker C, a left channel speaker L, and a right channel speaker R illustrated in FIG. 6A corresponds to the center channel speaker C, the left channel speaker L, and the right channel speaker R illustrated in FIG. 1A, detailed description thereof will not be provided here.

Referring to FIG. 6A, each of a left side channel speaker LS and a right side channel speaker RS is disposed at an angle in the range of 100 to 120 degrees in right and left directions of the reference point P1 where the center channel speaker C is disposed. In addition, the speaker unit 220 that may output 5.1 channel audio signals includes one sub woofer speaker LFE.

When the speaker unit 220 outputs 5.1 channel audio signals, the audio signal generator 210 down mixes 10.2 channel audio signals that are received audio signals into 5.1 channel audio signals.

Referring to FIG. 6B, left channel audio signal L, right channel audio signal R, center channel audio signal C, left side channel audio signal LS, right side channel audio signal RS, and woofer channel audio signal LFE that are down-mixed signals may be obtained using down-mixing equations defined in FIG. 6B.

In detail, the left side channel speaker LS for 5.1 channel illustrated in FIG. 6A corresponds to the left side channel speaker LS, the left back channel speaker LB, and the center height channel speaker CH that are included in the 10.2 channel audio system illustrated in FIGS. 1A through 1D.

Thus, referring to equation 611 in FIG. 6B, the left side channel audio signal LS for 5.1 channel may be obtained based on the left side channel audio signal LS for 10.2 channel, the left back channel audio signal LB for 10.2 channel, and the center height channel audio signal CH for 10.2 channel.

Since the down-mixing equations that are used in down-mixing the 10.2 channel audio signals into 5.1 channel audio signals are clearly defined in FIG. 6B, detailed description thereof will not be provided here.

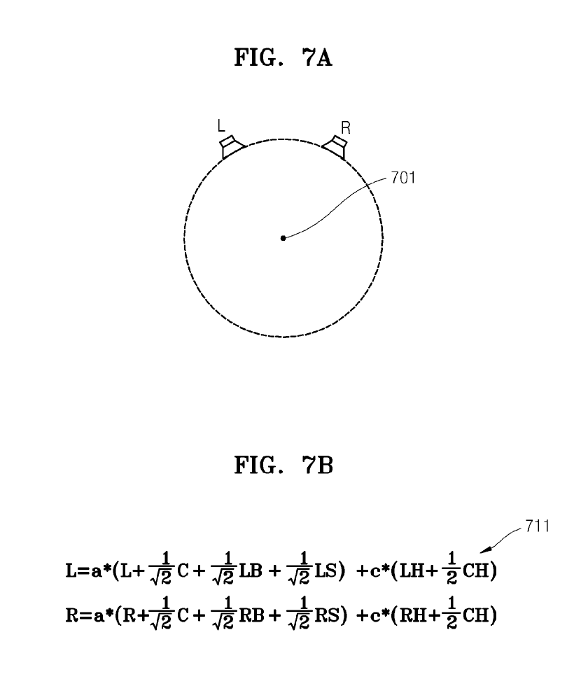

FIGS. 7A and 7B illustrate a method of down mixing audio signals according to another exemplary embodiment. In detail, FIG. 7A illustrates another example of speakers included in the speaker unit 220, and FIG. 7B illustrates another example of the down-mixing operation performed by the audio signal generator 210.

Referring to FIG. 7A, the speaker unit 220 may include 2 speakers L and R that are disposed around a sweet spot 701. That is, the speaker unit 220 may output 2.0 channel audio signals. Since each of a left channel speaker L and a right channel speaker R illustrated in FIG. 7A corresponds to the left channel speaker L and the right channel speaker R illustrated in FIG. 1A, detailed description thereof will not be provided here.

When the speaker unit 220 outputs 2.0 channel audio signals, the audio signal generator 210 down mixes 10.2 channel audio signals that are received audio signals into 2.0 channel audio signals.

Referring to FIG. 7B, each of left channel audio signal L and right channel audio signal R that are down-mixed and output signals may be obtained using down-mixing equations defined in FIG. 7B.

In detail, the left channel speaker L for 2.0 channel illustrated in FIG. 7A corresponds to the left channel speaker L, the left side channel speaker LS, the left back channel speaker LB, the left height channel speaker LH, and the center height channel speaker CH that are speakers disposed in a left direction of the reference point P1 in the 10.2 channel audio system illustrated in FIGS. 1A through 1D.

Thus, referring to equation 711 in FIG. 7B, the left channel audio signal L for 2.0 channel may be obtained based on the left channel audio signal L for 10.2 channel, the left side channel audio signal LS for 10.2 channel, the left back channel audio signal LB for 10.2 channel, the left height channel audio signal LH for 10.2 channel, and the center height channel audio signal CH for 10.2 channel.

Since the down-mixing equations that are used in down-mixing the 10.2 channel audio signals into 2.0 channel audio signals are clearly defined in FIG. 7B, detailed description thereof will not be provided here.

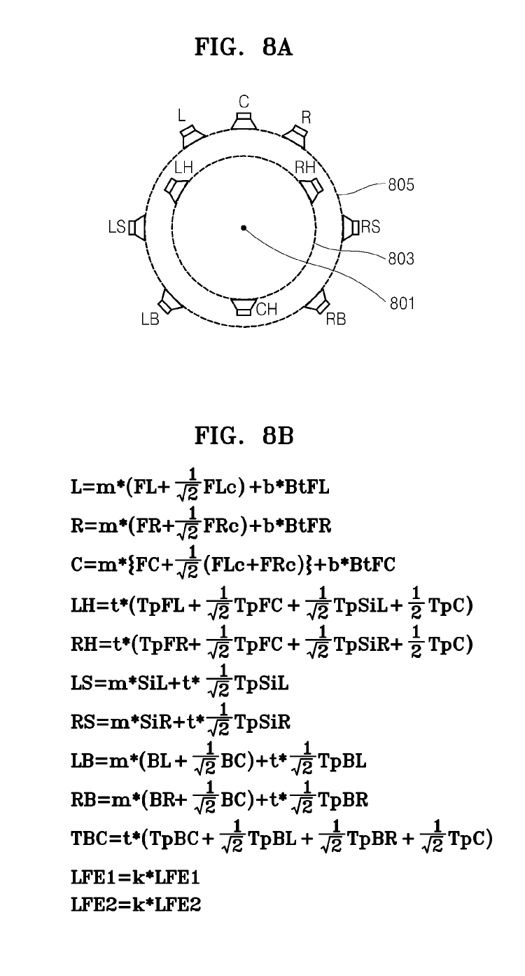

FIGS. 8A and 8B illustrate a method of down mixing audio signals according to another exemplary embodiment. The method of down mixing audio signals illustrated in FIGS. 8A and 8B may be performed by the audio system 200 of FIG. 2, in detail, by the audio signal generator 210. In addition, referring to FIG. 8A, the speaker unit 220 of the audio system 200 includes 12 speakers that may output 10.2 channel audio signals.

Referring to FIG. 8A, the speaker unit 220 includes 7 speakers L, R, C, LS, RS, LB, and RB that are disposed around a sweet spot 801. In addition, the speaker unit 220 includes 3 speakers LH, RH, and CH that are disposed on a vertical plane around the sweet spot 801. Also, the speaker unit 220 includes a left channel woofer speaker LFEL and a right channel woofer speaker LFER. The left channel woofer speaker LFEL and the right channel woofer speaker LFER that correspond to the speakers illustrated in FIG. 1D are not shown in FIG. 8A.

Since 7 speakers that are disposed on a plane 805 correspond to the speakers illustrated in FIG. 1A, detailed description thereof will not be provided here. In addition, since 3 speakers that are disposed on a vertical plane 803 correspond to the speakers illustrated in FIG. 1B, detailed description thereof will not be provided here.

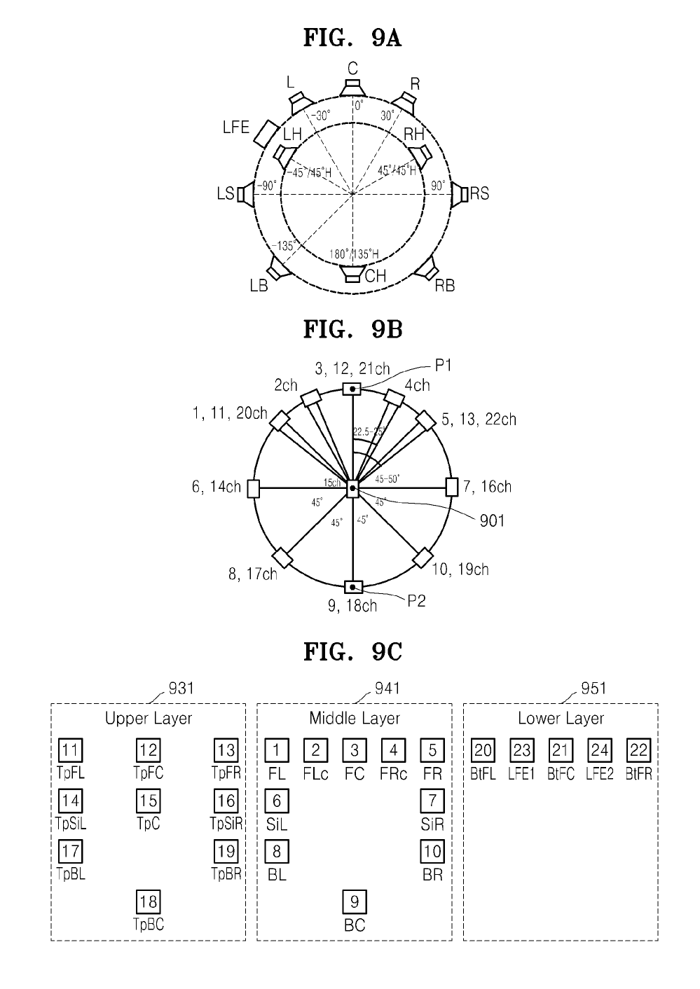

Down-mixing equations that are used in generating 10.2 channel audio signals by receiving 22.2 channel audio signals and by down mixing the received 22.2 channel audio signals by using the audio signal generator 210 of the audio system 200 are defined in FIG. 8B. In a method of down mixing audio signals according to another exemplary embodiment, 22.2 channel audio signals are down mixed into 10.2 channel audio signals according to the down-mixing equations defined in FIG. 8B. The 22.2 channel audio signals and the structure of speakers that output the 22.2 channel audio signals will be described below with reference to FIG. 9 in detail.

In addition, predetermined coefficients m, t, b, k, and l indicated on the down-mixing equations defined in FIG. 8B may be modified according to product or design specifications, such as an overall sound level, a maximum rating output, or the like of the audio system 200, similarly to the predetermined coefficients a, c, k, and l described in FIG. 3B.

FIGS. 9A through 9C illustrate an audio system for 22.2 channel that is used in a method of down mixing audio signals, according to another exemplary embodiment.

FIG. 9A illustrates an audio system that outputs 10.2 channel audio signals. FIG. 9B illustrates an audio system that outputs 22.2 channel audio signals. FIG. 9C illustrates the audio system that outputs 22.2 channel audio signals, in detail. The 22.2 channel audio signals include 22 normal-band audio signals and 2 low frequency effect (LFE) audio signals.

Since the audio system illustrated in FIG. 9A that outputs 10.2 channel audio signals corresponds to the audio system illustrated in FIGS. 1A through 1D, detailed description thereof will not be provided here.

Referring to FIG. 9B, the audio system for 22.2 channel includes 22 speakers that output 20 normal-band audio signals and 2 woofer speakers that output 2 LFE audio signals. FIG. 9B illustrates first through 22 channel speakers 1ch through 22ch that are 22 speakers and does not illustrate 2 woofer speakers.

Referring to FIG. 9C, the 20 normal-band audio signals as described above are output to 20 speakers that are disposed on three layers, i.e., an upper layer 931, a middle layer 941, and a lower layer 951.

In detail, a top front left channel speaker 11 that outputs top front left channel audio signal Top Front Left (TpFL), a top front center channel speaker 12 that outputs top front center channel audio signal Top Front Center (TpFC), a top front right channel speaker 13 that outputs top front right channel audio signal Top Front Right (TpFR), a top side left channel speaker 14 that outputs top side left channel audio signal Top Side Left (TpSiL), a top center channel speaker 15 that outputs top center channel audio signal Top Center (TpC), a top side right channel speaker 16 that outputs top side right channel audio signal Top Side Right (TpSiR), a top back left channel speaker 17 that outputs top back left channel audio signal Top Back Left (TpBL), a top back center channel speaker 18 that outputs top back center channel audio signal Top Back Center (TpBC), and a top back right channel speaker 19 that outputs top back right channel audio signal Top Back Right (TbBR) are disposed on the upper layer 931, as illustrated in FIGS. 9B and 9C.

In addition, a front left channel speaker 1 that outputs front left channel audio signal Front Left (FL), a front left center channel speaker 2 that outputs front left center channel audio signal Front Left center (FLc), a front center channel speaker 3 that outputs front center channel audio signal Front Center (FC), a front right center channel speaker 4 that outputs front right center audio signal Front Right center (FRc), a front right channel speaker 5 that outputs front right channel audio signal Front Right (FR), a side left channel speaker 6 that outputs side left channel audio signal Side Left (SiL), a side right channel speaker 7 that outputs side right channel audio signal Side Right (SiR), a back left channel speaker 8 that outputs back left channel audio signal Back Left (BL), a back center channel speaker 9 that outputs back center channel audio signal Back Center (BC), and a back right channel speaker 10 that outputs back right channel audio signal Back Right (BR) are disposed on the middle layer 941, as illustrated in FIGS. 9B and 9C.

In addition, a bottom front left channel speaker 20 that outputs bottom front left channel audio signal Bottom Front Left (BtFL), a bottom front center channel speaker 21 that outputs bottom front center channel audio signal Bottom Front Center (BtFC), a bottom front right channel speaker 22 that outputs bottom front right channel audio signal Bottom Front Right (BtFR), a first woofer speaker 23 that outputs first woofer channel audio signal Low Frequency Effect 1 (LFE1), and a second woofer speaker 24 that outputs second woofer channel audio signal Low Frequency Effect 2 (LFE2) are disposed on the lower layer 951, as illustrated in FIGS. 9B and 9C.

In detail, referring to FIGS. 9B and 9C, the top center channel speaker 15 that outputs top center channel audio signal Top Center (TpC) as audio signal corresponding to a fifteenth channel 15ch is disposed on a sweet spot 901.

Since the down-mixing equations that are used in down mixing received 22.2 channel audio signals are clearly defined in FIG. 8B, detailed description thereof will not be provided here.

FIG. 10 illustrates an audio system according to another exemplary embodiment.

Referring to FIG. 1A and FIG. 10, at least one first channel speaker 119 included in a horizontal plane speaker set of the audio system illustrated in FIG. 10 may include the left side channel speaker LS that is disposed at an angle in the range of 100 to 120 degrees (A1) in a left direction of the reference point P1. In addition, at least one second channel speaker 118 may include the right side channel speaker RS that is disposed at an angle in the range of 100 to 120 degrees (A1) in a right direction of the reference point P1. That is, the audio system illustrated in FIG. 10 may include the horizontal plane speaker set illustrated in FIG. 10, the vertical plane speaker sets illustrated in FIGS. 1B and 1C, and the woofer speaker set illustrated in FIG. 10. Thus, the audio system illustrated in FIG. 10 includes 5 speakers included in the horizontal plane speaker set, 3 speakers included in the vertical plane speaker set, and 2 speakers included in the woofer speaker set. That is, the audio system of FIG. 10 may include 8 speakers (5 speakers included in the horizontal plane speaker set+3 speakers included in the vertical plane speaker set) and 2 speakers included in the woofer speaker set and may output 8.2 channel audio signals.

Since the center channel speaker C, the left channel speaker L, and the right channel speaker R illustrated in FIG. 10 correspond to the center channel speaker C, the left channel speaker L, and the right channel speaker R illustrated in FIG. 1A, respectively, detailed description thereof will not be provided here.

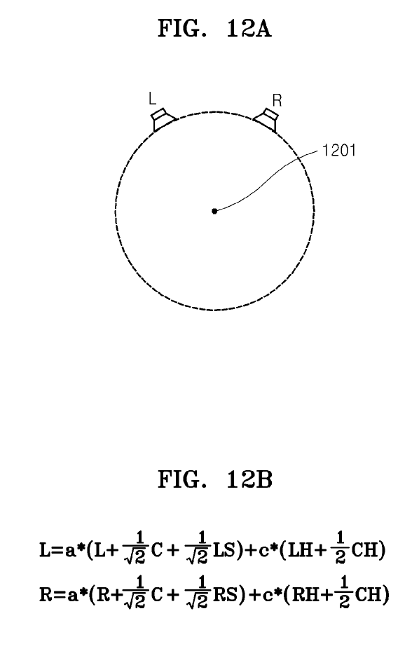

FIGS. 11 and 12 illustrate a method of down mixing audio signals whereby the audio system 200 receives the 8.2 channel audio signals as described above in FIG. 10 and down mixes the received 8.2 channel audio signals into 5.1 or 2.0 audio signals, according to other exemplary embodiments.

FIGS. 11A and 11B illustrate a method of down mixing audio signals according to another exemplary embodiment.

FIG. 11A illustrates speakers that are included in the speaker unit 220 and may output 5.1 channel audio signals. Since FIG. 11A corresponds to FIG. 6A, detailed description thereof will not be provided here.

FIG. 11B illustrates a method of down mixing audio signals whereby the 8.2 channel audio signals as described above in FIG. 10 are down mixed to generate 5.1 channel audio signals, according to another exemplary embodiment. When the speaker unit 220 outputs 5.1 channel audio signals, the audio signal generator 210 down mixes the received 8.2 channel audio signals into 5.1 channel audio signals.

Referring to FIG. 11B, each of left channel audio signal L, right channel audio signal R, center channel audio signal C, left side channel audio signal LS, right side channel audio signal RS, and woofer channel audio signal LFE that are down-mixed and output signals, may be obtained using down-mixing equations defined in FIG. 11B. Since the down-mixing equations that are used in down mixing the 8.2 channel audio signals into the 5.1 channel audio signals are clearly defined in FIG. 11B, detailed description thereof will not be provided here.

FIGS. 12A and 12B illustrate a method of down mixing audio signals according to another exemplary embodiment. In detail, FIG. 12A illustrates another example of speakers included in the speaker unit 220. FIG. 12B illustrates another example of the down-mixing operation performed by the audio signal generator 210.

Referring to FIG. 12A, the speaker unit 220 may include 2 speakers L and R that are disposed around a sweet spot 1201. That is, the speaker unit 220 may output 2.0 channel audio signals. Since FIG. 12A corresponds to FIG. 7A, detailed description thereof will not be provided here. In addition, the audio system 200, in detail, the audio signal generator 210 receives 8.2 channel audio signals and outputs down-mixed signals that are obtained by down mixing the received 8.2 channel audio signals to the speaker unit 220.

When the speaker unit 220 outputs 2.0 channel audio signals, the audio signal generator 210 down mixes the received 8.2 channel audio signals into 2.0 channel audio signals.

Referring to FIG. 12B, each of the left channel audio signal L and the right channel audio signal R that are down-mixed and output signals, may be obtained using down-mixing equations defined in FIG. 12B.

In detail, a left channel speaker L for 2.0 channel illustrated in FIG. 12A corresponds to the left channel speaker L, the left side channel speaker LS, the left height channel speaker LH, and the center height channel speaker CH that are disposed in left direction of the reference point P1 in the audio system for 8.2 channel illustrated in FIG. 10 in view of space.

Thus, referring to a first equation defined in FIG. 12B, left channel audio signal L for 2.0 channel may be obtained based on the left channel audio signal L for 8.2 channel, the left side channel audio signal LS for 8.2 channel, the left height channel audio signal LH, and the center height channel audio signal CH.

Since the down-mixing equations that are used in down mixing the 8.2 channel audio signals into the 2.0 channel audio signals are clearly defined in FIG. 12B, detailed description thereof will not be provided here.

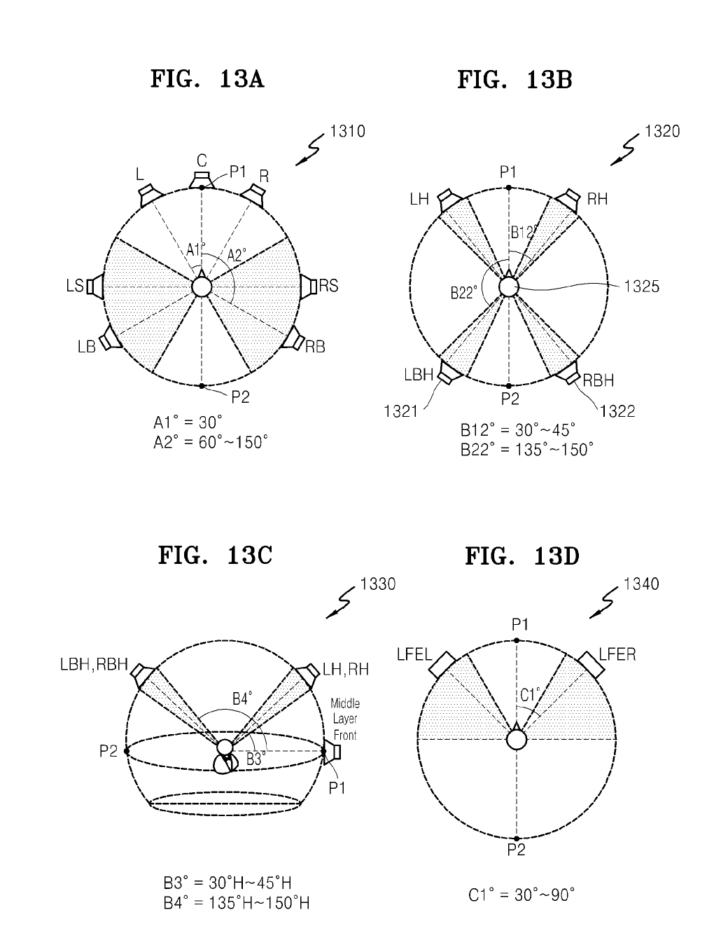

FIGS. 13A through 13D illustrate an audio system according to another exemplary embodiment. In detail, FIG. 13A illustrates a horizontal plane speaker set that is disposed on a horizontal plane of the audio system illustrated in FIGS. 13A through 13D. FIG. 13B illustrates an in-plane vertical plane speaker set that is disposed on a vertical plane of the audio system illustrated in FIGS. 13A through 13D. FIG. 13C illustrates a vertical plane speaker set that is disposed on the vertical plane of the audio system illustrated in FIGS. 13A through 13D in a three-dimensional manner. FIG. 13D illustrates a woofer speaker set that may be included in the audio system illustrated in FIGS. 1A through 1D.

Referring to FIGS. 13A through 13D, the audio system according to the current exemplary embodiment includes a horizontal plane speaker set 1310 that is disposed on the horizontal plane, as illustrated in FIG. 13A and vertical plane speaker sets 1320 and 1330 that are disposed on the vertical plane, as illustrated in FIGS. 13B and 13C. Also, the audio system according to the current exemplary embodiment may further include a woofer speaker set 1340 that is disposed, as illustrated in FIG. 13D. Since FIGS. 13A through 13D correspond to FIGS. 1A through 1D, detailed description thereof will not be provided here.

Referring to FIG. 13A, the horizontal plane speaker set 1310 may include 7 speakers C, L, R, LS, RS, LB, and RB, as in the horizontal plane speaker set 110 as described in FIG. 1A, or 5 speakers C, L, R, LS, and RS. FIG. 13A illustrates the case where the horizontal plane speaker set 1310 includes 7 speakers C, L, R, LS, RS, LB, and RB.

Referring to FIGS. 13B and 13C, each of the vertical plane speaker sets 1320 and 1330 includes a left height channel speaker LH and a right height channel speaker RH that are disposed at an angle in the range of 30 to 45 degrees (B12) in left and right direction of a reference point P1 and at an angle in the range of 30 to 45 degrees (B3) in the vertical direction of the reference point P1, respectively.

The vertical plane speaker sets 1320 and 1330 include a left back height channel speaker Left Back Height (LBH) and a right back height channel speaker Right Back Height (RBH) that are disposed at an angle in the range of 135 to 150 degrees (B22) in the left and right horizontal directions of the reference point P1 and at an angle in the range of 135 to 150 degrees (B4) in the vertical direction of the reference point P1, respectively.

In the audio system illustrated in FIGS. 13A through 13D, when 7 speakers C, L, R, LS, RS, LB, and RB are included in the horizontal plane speaker set 1310, total 11 speakers that output audio signal in normal frequency bands, i.e., 7 speakers C, L, R, LS, RS, LB, and RB are included in the horizontal plane speaker set 1310, and 4 speakers LH, RH, LBH, and RBH are included in the vertical plane speaker sets 1320 and 1330. Speakers that output 2 LFE audio signals, i.e., the left channel woofer speaker LFEL and the right channel woofer speaker LFER are included in the woofer speaker set 1340. Thus, the audio system illustrated in FIG. 13 may output 11.2 channel audio signals.

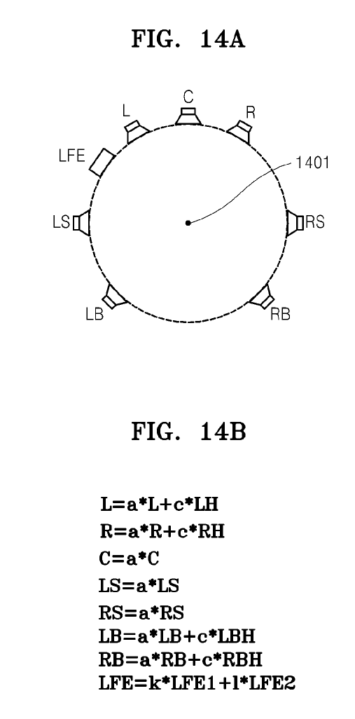

Hereinafter, a method of down mixing the 11.2 channel audio signals as described above in FIG. 13 into 7.1, 5.1 or 2.0 channel audio signals according to another exemplary embodiment will be described with reference to FIGS. 14 through 16 in detail.

FIGS. 14A and 14B illustrate a method of down mixing audio signals according to another exemplary embodiment. In addition, FIGS. 14A and 14B illustrate the case where the audio signal generator 210 receives the 11.2 channel audio signals as described above in FIG. 13 and down mixes the received 11.2 channel audio signals into 7.1 channel audio signals.

FIG. 14A illustrates another example of speakers included in the speaker unit 220. FIG. 14B illustrates another example of the down-mixing operation performed by the audio signal generator 210.

Referring to FIG. 14A, the speaker unit 220 may include 8 speakers L, R, C, LS, RS, LB, RB, and LFE that are disposed around a sweet spot 1401. Since FIG. 14A corresponds to FIG. 3A, detailed description thereof will not be provided here.

Referring to FIG. 14B, each of left channel audio signal L, right channel audio signal R, center channel audio signal C, left side channel audio signal LS, right side channel audio signal RS, left back channel audio signal LB, right back channel audio signal RB, and woofer channel audio signal LFE that are down-mixed and output signals, may be obtained using down-mixing equations defined in FIG. 14B. Since the down-mixing equations are clearly defined in FIG. 14B, detailed description thereof will not be provided here.

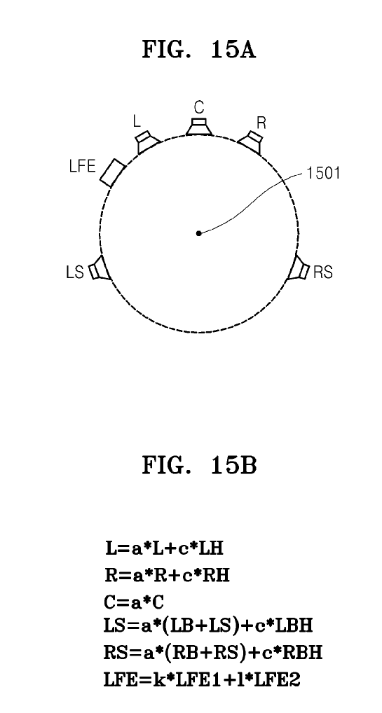

FIGS. 15A and 15B illustrate a method of down mixing audio signals according to another exemplary embodiment. In detail, FIG. 15A illustrates another example of speakers included in the speaker unit 220. FIG. 15B illustrates another example of the down-mixing operation performed by the audio signal generator 210.

Referring to FIG. 15A, the speaker unit 220 may include L, R, C, LS, RS, and LFE that are disposed around a sweet spot 1501. That is, the speaker unit 220 may output 5.1 channel audio signals. Since FIG. 15A corresponds to FIG. 6A, detailed description thereof will not be provided here.

When the speaker unit 220 outputs 5.1 channel audio signals, the audio signal generator 210 down mixes the received 11.2 channel audio signals into 5.1 channel audio signals.

Referring to FIG. 15B, each of left channel audio signal L, right channel audio signal R, center channel audio signal C, left side channel audio signal LS, right side channel audio signal RS, and woofer channel audio signal LFE that are down-mixed and output signals, may be obtained using down-mixing equations defined in FIG. 15B. Since the down-mixing equations that are used in down mixing the 11.2 channel audio signals into 5.1 channel audio signals are clearly defined in FIG. 15B, detailed description thereof will not be provided here.

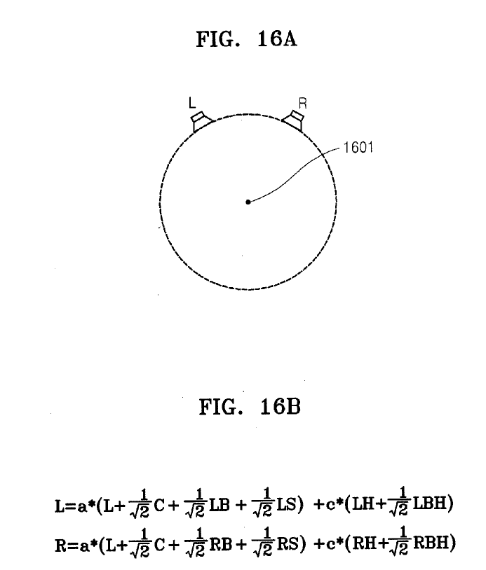

FIGS. 16A and 16B illustrate a method of down mixing audio signals according to another exemplary embodiment. FIG. 16A illustrates another example of speakers included in the speaker unit 220. FIG. 16B illustrates another example of the down-mixing operation performed by the audio signal generator 210.

Referring to FIG. 16A, the speaker unit 220 may include 2 speakers L and R that are disposed around a sweet spot 1601. That is, the speaker unit 220 may output 2.0 channel audio signals. Since FIG. 16A corresponds to FIG. 7A, detailed description thereof will not be provided here.

When the speaker unit 220 outputs 2.0 channel audio signals, the audio signal generator 210 down mixes received 11.2 channel audio signals into 2.0 channel audio signals.

Referring to FIG. 16B, each of left channel audio signal L and right channel audio signal R that are down-mixed and output, may be obtained using down-mixing equations defined in FIG. 16B.

In addition, the horizontal plane speaker set 1310 of the audio system illustrated in FIGS. 13A through 13D may include 5 speakers L, R, C, LS, and RS except for a left back channel speaker LB and a right back channel speaker RB. That is, the horizontal plane speaker set 1310 included in the audio system illustrated in FIG. 13 may be constituted together with the speakers illustrated in FIG. 10. In this case, total 11 speakers L, R, C, LS, RS, LH, RH, LBH, RBH, LFEL, and LFER are included in the audio system of FIG. 13, and the audio system may output 9.2 channel audio signals.

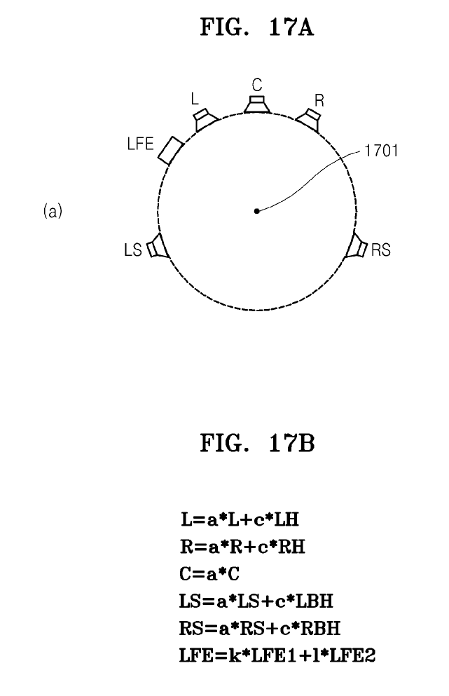

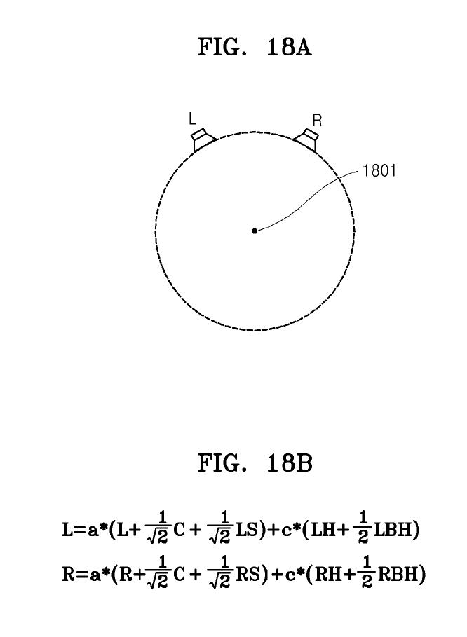

Hereinafter, a method of down mixing the 9.2 channel audio signals as described above into 5.1 or 2.0 channel audio signals according to another exemplary embodiment will be described with reference to FIGS. 17 and 18 in detail.

FIGS. 17A and 17B illustrate a method of down mixing audio signals according to another exemplary embodiment. In detail, FIG. 17A illustrates another example of speakers included in the speaker unit 220. FIG. 17B illustrates another example of the down-mixing operation performed by the audio signal generator 210.

Referring to FIG. 17A, the speaker unit 220 may include 6 speakers L, R, C, LS, RS, and LFE that are disposed around a sweet spot 1701. That is, the speaker unit 220 may output 5.1 channel audio signals. Since FIG. 17A corresponds to FIG. 6A, detailed description thereof will not be provided here.

When the speaker unit 220 outputs 5.1 channel audio signals, the audio signal generator 210 down mixes received 9.2 channel audio signals into 5.1 channel audio signals.

Referring to FIG. 17B, each of left channel audio signal L, right channel audio signal R, center channel audio signal C, left side channel audio signal LS, right side channel audio signal RS, and woofer channel audio signal LFE that are down-mixed and output, may be obtained using down-mixing equations defined in FIG. 17B. Since the down-mixing equations that are used in down mixing the 9.2 channel audio signals into the 5.1 channel audio signals are clearly defined in FIG. 17B, detailed description thereof will be not provided here.

FIGS. 18A and 18B illustrate a method of down mixing audio signals according to another exemplary embodiment.

FIG. 18A illustrates another example of speakers included in the speaker unit 220. FIG. 18B illustrates another example of the down-mixing operation performed by the audio signal generator 210.

Referring to FIG. 18A, the speaker unit 220 may include 2 speakers L and R that are disposed around a sweet spot 1801. That is, the speaker unit 220 may output 2.0 channel audio signals. Since FIG. 18A corresponds to FIG. 7A, detailed description thereof will not be provided here.

When the speaker unit 220 outputs 2.0 channel audio signals, the audio signal generator 210 down mixes received 9.2 channel audio signals into 2.0 channel audio signals.

Referring to FIG. 18B, each of left channel audio signal L and right channel audio signal R that are down-mixed and output, may be obtained using down-mixing equations defined in FIG. 18B.

As described above, in an audio system and a method of down mixing audio signals using the audio system according to the one or more exemplary embodiments, a maximized sense of realism and a maximized three-dimensional effect may be provided to a user. In detail, in an audio system according to the one or more exemplary embodiments, a sense of realism and a three-dimensional effect that are the same as or very similar to those that may be provided by a 22.2 channel audio system may be provided to the user by using only speakers that may output 10.2, 8.2, 11.2 or 9.2 channel audio signals.

In addition, in a method of down mixing audio signals according to the one or more exemplary embodiments, 10.2, 8.2, 11.2 or 9.2 channel audio signals may be down mixed into 7.1, 5.1 or 2.0 channel audio signals so that a reduction in a sense of realism and a three-dimensional effect that occurs during down-mixing may be minimized and compatibility between existing multi-channel audio systems and the audio system according to one or more exemplary embodiments may be maintained.

While exemplary embodiments have been particularly shown and described, it will be understood by those of ordinary skill in the art that various changes in form and details may be made therein without departing from the spirit and scope of the present invention as defined by the following claims.

What is claimed is:

1. An audio system comprising:
a horizontal plane speaker set comprising a center channel speaker that is disposed at a reference point, a left channel speaker and a right channel speaker that are disposed at points that respectively correspond to 30 degrees in left and right directions of the reference point, and at least one first channel speaker and at least one second channel speaker that are disposed at an angle in a range of 60 to 150 degrees in left and right directions of the reference point, respectively; and
a vertical plane speaker set comprising a left height channel speaker and a right height channel speaker that are respectively disposed at an angle in a range of 30 to 45 degrees in left and right directions of the reference point and at an angle in a range of 30 to 45 degrees in a vertical direction of the reference point, and a center height channel speaker that is disposed at an angle in a range of 90 to 150 degrees in the vertical direction of the reference point.

2. The audio system of claim 1, wherein the at least one first channel speaker comprises a left side channel speaker and a left back channel speaker that are disposed at an angle in a range of 60 to 150 degrees in the left direction of the reference point, and the at least one second channel speaker comprises a right side channel speaker and a right back channel speaker that are disposed at an angle in a range of 60 to 150 degrees in the right direction of the reference point.

3. The audio system of claim 2, wherein the left side channel speaker is disposed at an angle that is adjacent to 60 degrees in the left direction of the reference point, and the left back channel speaker is disposed at an angle that is adjacent to 150 degrees in the left direction of the reference point, and the right side channel speaker is disposed at an angle that is adjacent to 60 degrees in the right direction of the reference point, and the right back channel speaker is disposed at an angle that is adjacent to 150 degrees in the right direction of the reference point.

4. The audio system of claim 1, further comprising a woofer speaker set comprising at least one sub woofer speaker.

5. The audio system of claim 4, wherein the woofer speaker set comprises a left channel woofer speaker and a right channel woofer speaker that are respectively disposed at an angle in a range of 30 to 90 degrees in left and right directions of the reference point.

6. The audio system of claim 4, wherein the woofer speaker set comprises one of a left channel woofer speaker and a right channel woofer speaker that are respectively disposed at an angle in a range of 30 to 90 degrees in left and right directions of the reference point.

7. The audio system of claim 1, wherein the at least one first channel speaker comprises a left side channel speaker, and the at least one second channel speaker comprises a right side channel speaker,
wherein the left side channel speaker and the right side channel speaker are respectively disposed at an angle in a range of 100 to 120 degrees in left and right directions of the reference point.

8. The audio system of claim 1, wherein the center channel speaker, the left channel speaker, the right channel speaker, the at least one first channel speaker, and the at least one second channel speaker are disposed in a first plane; and
wherein the left height channel speaker, the right height channel speaker, and the center height channel speaker are disposed in a second plane that is different from the first plane.

9. An audio system comprising:
a horizontal plane speaker set comprising a center channel speaker that is disposed at a reference point, a left channel speaker and a right channel speaker that are disposed at points that respectively correspond to 30 degrees in left and right directions of the reference point, and at least one first channel speaker and at least one second channel speaker that are disposed at an angle in a range of 60 to 150 degrees in left and right directions of the reference point, respectively; and
a vertical plane speaker set comprising a left height channel speaker and a right height channel speaker that are respectively disposed at an angle in a range of 30 to 45 degrees in left and right directions of the reference point and at an angle in a range of 30 to 45 degrees in a vertical direction of the reference point, and a left back height channel speaker and a right back height channel speaker that are respectively disposed at an angle in a range of 135 to 150 degrees in left and right directions of the reference point and at an angle in a range of 135 to 150 degrees in the vertical direction of the reference point.

10. The audio system of claim 9, wherein the at least one first channel speaker comprises a left side channel speaker and a left back channel speaker that are disposed at an angle in a range of 60 to 150 degrees in the left direction of the reference point, and the at least one second channel speaker comprises a right side channel speaker and a right back channel speaker that are disposed at an angle in a range of 60 to 150 degrees in the right direction of the reference point.

11. The audio system of claim 9, wherein the left side channel speaker is disposed at an angle that is adjacent to 60 degrees in the left direction of the reference point, and the left back channel speaker is disposed at an angle that is adjacent to 150 degrees in the left direction of the reference point, and the right side channel speaker is disposed at an angle that is adjacent to 60 degrees in the right direction of the reference point, and the right back channel speaker is disposed at an angle that is adjacent to 150 degrees in the right direction of the reference point.

12. The audio system of claim 9, further comprising a woofer speaker set comprising at least one sub woofer speaker.

13. The audio system of claim 12, wherein the woofer speaker set comprises a left channel woofer speaker and a right channel woofer speaker that are respectively disposed at an angle in a range of 30 to 90 degrees in left and right directions of the reference point.

14. The audio system of claim 9, wherein the horizontal plane speaker set comprises a left side channel speaker and a right side channel speaker that are respectively disposed at an angle in a range of 100 to 120 degrees in left and right directions of the reference point.

15. The audio system of claim 9, wherein the center channel speaker, the left channel speaker, the right channel speaker, the at least one first channel speaker, and the at least one second channel speaker are disposed in a first plane; and
wherein the left height channel speaker, the right height channel speaker, the left back height channel speaker, and the right back height channel speaker are disposed in a second plane that is different from the first plane.

16. An audio system comprising:
an audio signal generator that receives predetermined audio signals and down mixes the predetermined audio signals according to a number of speakers of a speaker unit and generates at least one down-mixed signal; and
the speaker unit comprising at least one speaker that outputs the at least one down-mixed signal,
wherein the predetermined audio signals comprise center channel audio signals corresponding to a center channel speaker that is disposed at a reference point, left channel audio signals and right channel audio signals that respectively correspond to a left channel speaker and a right channel speaker that are disposed at points that respectively correspond to 30 degrees in left and right directions of the reference point, at least one first channel audio signals and at least one second channel audio signals that respectively correspond to at least one first channel speaker and at least one second channel speaker that are disposed at an angle in a range of 60 to 150 degrees in left and right directions of the reference point, respectively, left height channel audio signals and right height channel audio signals that respectively correspond to a left height channel speaker and a right height channel speaker that are respectively disposed at an angle in a range of 30 to 45 degrees in left and right directions of the reference point and at an angle in a range of 30 to 45 degrees in a vertical direction of the reference point, and center height channel audio signals that correspond to a center height channel speaker that is disposed at an angle in a range of 90 to 150 degrees in the vertical direction of the reference point.

17. The audio system of claim 16, wherein the speaker unit comprises speakers that output audio signals comprising at least one of 7.1, 5.1, and 2.0 channel audio signals.

18. A method of down mixing audio signals, comprising:
receiving audio signals comprising center channel audio signal C corresponding to a center channel speaker that is disposed at a reference point, left channel audio signal L and right channel audio signal R that respectively correspond to a left channel speaker and a right channel speaker that are disposed at points that respectively correspond to 30 degrees in left and right directions of the reference point, at least one first channel audio signals and at least one second channel audio signals that respectively correspond to at least one first channel speaker and at least one second channel speaker that are disposed at an angle in a range of 60 to 150 degrees in left and right directions of the reference point, respectively, left height channel audio signal LH and right height channel audio signal RH that respectively correspond to a left height channel speaker and a right height channel speaker that are respectively disposed at an angle in a range of 30 to 45 degrees in left and right directions of the reference point, and center height channel audio signal CH that corresponds to a center height channel speaker that is disposed at an angle in a range of 90 to 150 degrees in the vertical direction of the reference point; and
generating down-mixed signals by down mixing the received audio signals into at least one of 7.1, 5.1 or 2.0 channel audio signals,
wherein the generating of the down-mixed signals comprises generating the down-mixed signals corresponding to one channel based on at least one predetermined channel audio signal among the received audio signals that corresponds to at least one speaker that is disposed at an angle of 150 degrees in a vertical direction of the reference point.

19. The method of claim 18, wherein the at least one first channel audio signals comprises a left side channel audio signal LS and a left back channel audio signal;
wherein the at least one second channel audio signals comprises a right side channel audio signal RS and a right back channel audio signal RB; and
wherein the receiving of the audio signals comprises receiving 10.2 channel audio signals comprising the center channel audio signal C, the left channel audio signal L and the right channel audio signal R, and left side channel audio signal LS and left back channel audio signal LB, the right side channel audio signal RS and right back channel audio signal RB, the left height channel audio signal LH and right height channel audio signal RH, the center height channel audio signal CH, and left woofer channel audio signal LFEL and right woofer channel audio signal LFER that respectively correspond to a left channel woofer speaker and a right channel woofer speaker that are respectively disposed at an angle in a range of 30 to 90 degrees in left and right directions of the reference point.

20. The method of claim 19, wherein the generating of the down-mixed signals comprises down mixing the received 10.2 channel audio signals into 7.1 channel audio signals, and the left height channel audio signal LH and the right height channel audio signal RH respectively correspond to the left height channel speaker and the right height channel speaker that are speakers disposed at an angle that is adjacent to 150 degrees in the vertical direction of the reference point, and the generating of the down-mixed signals is performed using the following down-mixing equations:
$$L = a * L + c * LH$$
$$R = a * R + c * RH$$
$$C = a * C$$
$$LS = a * LS$$
$$RS = a * RS$$
$$LB = a * LB + c * \frac{1}{\sqrt{2}} CH$$
$$RB = a * RB + c * \frac{1}{\sqrt{2}} CH$$
$$LFE = k * LFE 1 + l * LFE 2 ,$$
where terms on the left side of the down-mixing equations represent the down-mixed signals, and terms on the right side of the down-mixing equations represent predetermined channel audio signals that belong to the 10.2 channel audio signals, and where a, c, k, and l are predetermined coefficients.

21. The method of claim 19, wherein the generating of the down-mixed signals comprises down mixing the received 10.2 channel audio signals into 7.1 channel audio signals, and the left height channel audio signal LH and the right height channel audio signal RH respectively correspond to the left height channel speaker and the right height channel speaker that are speakers disposed at an angle that is adjacent to 90 degrees in the vertical direction of the reference point, and the generating of the down-mixed signals is performed using the following down-mixing equations:
$$L = a * L + c * LH$$
$$R = a * R + c * RH$$
$$C = a * C$$
$$LS = a * LS + c * \frac{1}{\sqrt{2}} CH$$
$$RS = a * RS + c * \frac{1}{\sqrt{2}} CH$$
$$LB = a * LB$$
$$RB = a * RB$$
$$LFE = k * LFE 1 + l * LFE 2 ,$$
where the terms on the left side of the down-mixing equations represent the down-mixed signals, and the terms on the right side of the down-mixing equations represent predetermined channel audio signals that belong to the 10.2 channel audio signals, and where a, c, k, and l are predetermined coefficients.

22. The method of claim 19, wherein the generating of the down-mixed signals comprises down mixing the received 10.2 channel audio signals into 5.1 channel audio signals, and the generating of the down-mixed signals is performed using the following down-mixing equations:
$$L = a * L + c * LH$$
$$R = a * R + c * RH$$
$$C = a * C$$
$$LS = a * ( LB + LS ) + c * \frac{1}{\sqrt{2}} CH$$
$$RS = a * ( RB + RS ) + c * \frac{1}{\sqrt{2}} CH$$
$$LFE = k * LFE 1 + l * LFE 2 ,$$
where the terms on the left side of the down-mixing equations represent the down-mixed signals, and the terms on the right side of the down-mixing equations represent predetermined channel audio signals that belong to the 10.2 channel audio signals, and where a, c, k, and l are predetermined coefficients.

23. The method of claim 19, wherein the generating of the down-mixed signals comprises down mixing the received 10.2 channel audio signals into 2.0 channel audio signals, and the generating of the down-mixed signals is performed using the following down-mixing equations:
$$L = a * ( L + \frac{1}{\sqrt{2}} C + \frac{1}{\sqrt{2}} LB + \frac{1}{\sqrt{2}} LS ) + c * ( LH + \frac{1}{2} CH )$$
$$R = a * ( R + \frac{1}{\sqrt{2}} C + \frac{1}{\sqrt{2}} RB + \frac{1}{\sqrt{2}} RS ) + c * ( RH + \frac{1}{2} CH ) ,$$
where the terms on the left side of the down-mixing equations represent the down-mixed signals, and the terms on the right side of the down-mixing equations represent predetermined channel audio signals that belong to the 10.2 channel audio signals, and where a and c are predetermined coefficients.

24. The method of claim 18, wherein the receiving of the audio signals comprises receiving 8.2 channel audio signals comprising the at least one first channel audio signals, the center channel audio signal C, the left channel audio signal L and the right channel audio signal R, the at least one second channel audio signals, left height channel audio signal LH and right height channel audio signal RH, center height channel audio signal CH, and left woofer channel audio signal LFEL and right woofer channel audio signal LFER that respectively correspond to a left channel woofer speaker and a right channel woofer speaker that are respectively disposed at an angle in a range of 30 to 90 degrees in left and right directions of the reference point;
wherein the at least one first channel audio signals comprises left side channel audio signal LS, and the at least one second channel audio signals comprises right side channel audio signal RS.

25. The method of claim 24, wherein the generating of the down-mixed signals comprises down mixing the received 8.2 channel audio signals into 5.1 channel audio signals, and the generating of the down-mixed signals is performed using the following down-mixing equations:
$$L = a * L + c * LH$$
$$R = a * R + c * RH$$
$$C = a * C$$
$$LS = a * LS + c * \frac{1}{\sqrt{2}} CH$$
$$RS = a * RS + c * \frac{1}{\sqrt{2}} CH$$
$$LFE = k * LFE 1 + l * LFE 2 ,$$
where the terms on the left side of the down-mixing equations represent the down-mixed signals, and the terms on the right side of the down-mixing equations represent predetermined channel audio signals that belong to the 8.2 channel audio signals, and where a, c, k, and l are predetermined coefficients.

26. The method of claim 24, wherein the generating of the down-mixed signals comprises down mixing the received 8.2 channel audio signals into 2.0 channel audio signals, and the generating of the down-mixed signals is performed using the following down-mixing equations:
$$L = a * ( L + \frac{1}{\sqrt{2}} C + \frac{1}{\sqrt{2}} LS ) + c * ( LH + \frac{1}{2} CH )$$
$$R = a * ( R + \frac{1}{\sqrt{2}} C + \frac{1}{\sqrt{2}} RS ) + c * ( RH + \frac{1}{2} CH ) ,$$
where the terms on the left side of the down-mixing equations represent the down-mixed signals, and the terms on the right side of the down-mixing equations represent predetermined channel audio signals that belong to the 8.2 channel audio signals, and where a and c.

27. An apparatus for down-mixing signals, the apparatus comprising:
an audio signal generator that receives predetermined audio signals and down mixes the predetermined audio signals to generate at least one down-mixed signal according to a number of speakers to which the at least one down-mixed signal is output;
wherein the predetermined audio signals comprise center channel audio signals corresponding to a center channel speaker that is disposed at a reference point, left channel audio signals and right channel audio signals that respectively correspond to a left channel speaker and a right channel speaker that are disposed at points that respectively correspond to 30 degrees in left and right directions of the reference point, at least one first channel audio signals and at least one second channel audio signals that respectively correspond to at least one first channel speaker and at least one second channel speaker that are disposed at an angle in a range of 60 to 150 degrees in left and right directions of the reference point, respectively, left height channel audio signals and right height channel audio signals that respectively correspond to a left height channel speaker and a right height channel speaker that are respectively disposed at an angle in a range of 30 to 45 degrees in left and right directions of the reference point and at an angle in a range of 30 to 45 degrees in a vertical direction of the reference point, and center height channel audio signals that correspond to a center height channel speaker that is disposed at an angle in a range of 90 to 150 degrees in the vertical direction of the reference point.
